(19) United States
(12) Patent Application Publication
(10) Pub. No.: US 2008/0228389 A1
(43) Pub. Date: Sep. 18, 2008

(54) Route-selection-supporting device, method, and program

(75) Inventors: Toshihiro Kano, Nagakute (JP); Junichiro Igawa, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-shi (JP)

(21) Appl. No.: 12/073,005

(22) Filed: Feb. 28, 2008

(30) Foreign Application Priority Data
Mar. 14, 2007 (JP) 2007-065672

(51) Int. Cl. G01C 21/26

(52) U.S. Cl. 701/204

(57) ABSTRACT

Devices, methods, and programs display a map on a display. The devices, methods, and programs accept a selection of a continuous road route on the map as a planned travel route, the planned travel route having an endpoint. The devices, methods, and programs estimate an endpoint-arrival time, the endpoint-arrival time representing a time at which a vehicle traveling the planned travel route can reach the endpoint. The devices, methods, and programs obtain traffic information representing the state of traffic for travel beginning at the endpoint at the endpoint-arrival time, and display the obtained traffic information on the display.

### INCORPORATION BY REFERENCE

The disclosure of Japanese Patent Application No. 2007-065672, filed on Mar. 14, 2007, including the specification, drawings and abstract is incorporated herein by reference in its entirety.

### BACKGROUND

1. Related Technical Fields

Related technical fields include route-selection-supporting devices and methods for providing support for selection of a planned travel route.

2. Related Art

The technology for displaying traffic information for different time segments in one screen is known (see, e.g., Japanese Unexamined Patent Application Publication No. 2006-162323). In the related art, an estimated arrival time at which a vehicle can reach an arbitrary point from the present location is obtained on the basis of traffic information for each time segment. Traffic information for a time segment including the estimated arrival time is displayed. Additionally, a provisional destination is set and traffic information concerning the vicinity of the provisional destination is displayed, the provisional destination is set as a fixed destination, and a recommended route to the fixed destination is displayed.

### SUMMARY

In the related art, it is difficult to provide accurate traffic information that is referred to in a case where a user sets a planned travel route himself/herself.

In other words, in the related art, although traffic information for each time segment is provided, it is difficult for a user to select a route himself/herself on the basis of such traffic information. Accordingly, even when various types of traffic information are provided, it is difficult for a user to estimate a more preferable route himself/herself on the basis of the provided traffic information, and to set the more preferable route as a planned travel route.

Additionally, even when a provisional destination is set as described above, it is difficult to accurately calculate an estimated arrival time without determining a detailed route to the provisional destination. Accordingly, even when a provisional destination is determined as described above, an estimated arrival time at which a vehicle can reach the provisional destination is only roughly estimated, and traffic information provided as information for the estimated arrival time is not accurate.

Exemplary implementations of the broad principles described herein provide accurate traffic information that can be referred to when a user sets a planned travel route himself/herself.

Exemplary implementations provide devices, methods, and programs that display a map on a display. The devices, methods, and programs accept a selection of a continuous road route on the map as a planned travel route, the planned travel route having an endpoint. The devices, methods, and programs estimate an endpoint-arrival time, the endpoint-arrival time representing a time at which a vehicle traveling the planned travel route can reach the endpoint. The devices, methods, and programs obtain traffic information representing the state of traffic for travel beginning at the endpoint at the endpoint-arrival time, and display the obtained traffic information on the display.

### BRIEF DESCRIPTION OF THE DRAWINGS

Exemplary implementations will now be described with reference to the accompanying drawings, wherein:

FIG. 1 is a block diagram of an exemplary navigation apparatus including a an exemplary route-selection-supporting device;

FIG. 2 is an illustration showing exemplary estimated time information included in link information;

FIG. 3 is an illustration showing exemplary section information;

FIG. 4 is an illustration showing exemplary congestion information;

FIG. 5 is a flowchart showing an exemplary route-selection-supporting method;

FIG. 6 is an illustration showing an exemplary display; and

FIG. 7 is an illustration showing an exemplary display.

### DETAILED DESCRIPTION OF EXEMPLARY IMPLEMENTATIONS

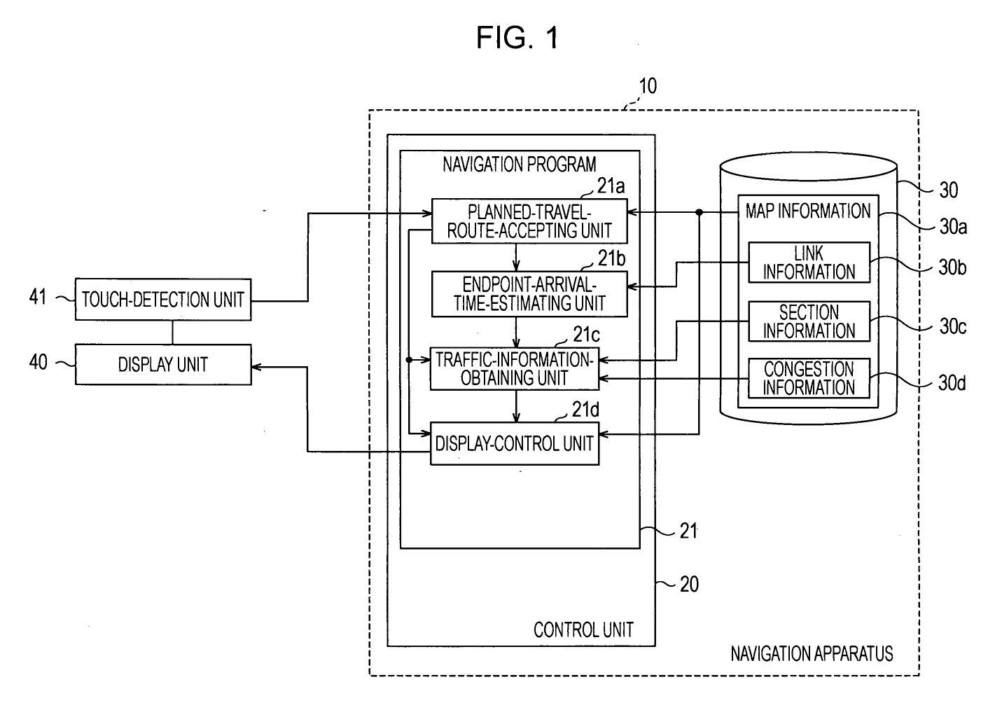

FIG. 1 is a block diagram showing an exemplary configuration of a navigation apparatus 10 including an exemplary route-selection-supporting device. The navigation apparatus 10 may include a controller (control unit 20) having a central processing unit (CPU), a random-access memory (RAM), and a read-only memory (ROM), and so forth, and a memory (storage medium 30). The control unit 20 is capable of executing programs stored in the storage medium 30 or the ROM. In this example, the control unit 20 can execute a navigation program 21. One of the functions of the navigation program 21 is to provide a user support for selection of a planned travel route.

A subject vehicle (a vehicle in which the navigation apparatus 10 is mounted) may include a global positioning system (GPS) receiver, a vehicle speed sensor, and/or a speaker, which are not shown in FIG. 1. The subject vehicle may also include a display unit 40, a touch-detection unit 41, and so forth in order to run the navigation program 21. Signals between each of these units and the control unit 20 may be sent or received using an interface between the unit and the control unit 20, which is not shown in FIG. 1. When the control unit 20 executes the navigation program 21, the above-described units may obtain various types of information. The control unit 20 performs, for example, route guidance based on a planned travel route on the basis of the various types of information.

The display unit 40 displays an image, for example, a map (described below), on the basis of a control signal output from the control unit 20. On a display surface of the display unit 40, the touch-detection unit 41, which detects being touched with a finger, or the like, is provided. The touch-detection unit 41 may output a signal indicating a position touched with a finger, or the like, on the display surface. The control unit 20 may receive this signal to identify the position touched with a finger on the display surface.

In the storage medium 30, map information 30a used to perform guidance by the navigation program 21 may be stored. The map information 30a may include, not only data showing landmarks, but also link information 30b, section information 30c, and congestion information 30d.

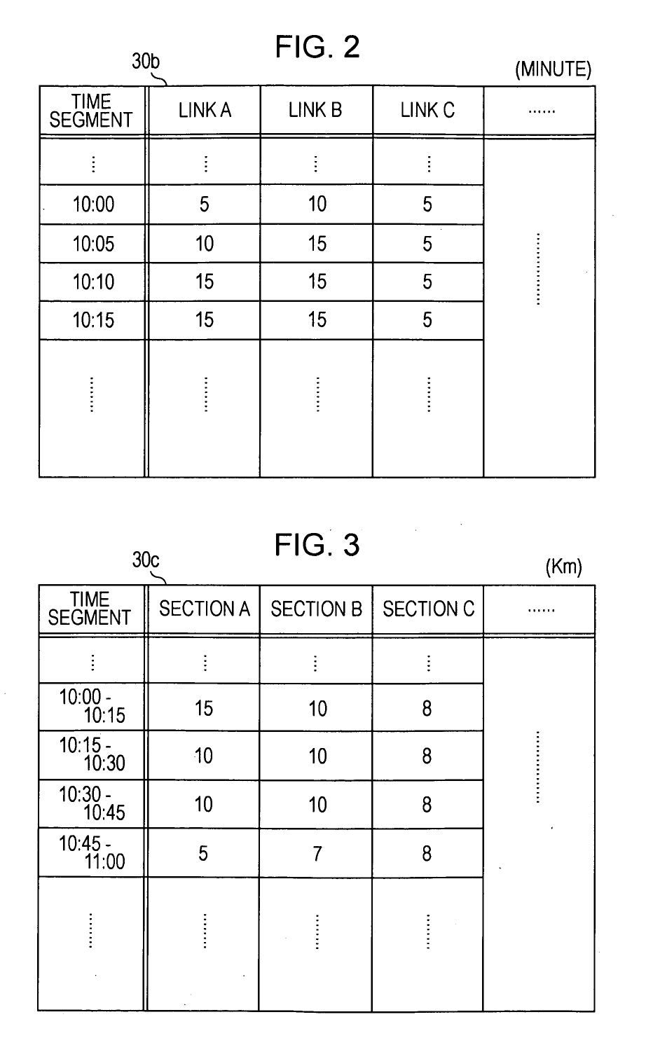

The link information 30b includes data showing coordinates of nodes set on roads and link data showing connections between nodes. Additionally, in this example, the link information 30b may include estimated time information showing an estimated travel time for each time segment for each link. FIG. 2 is an illustration showing an example of the estimated time information included in the link information 30b. In this example, time segments are defined on the basis of a predetermined time interval (a five-minute interval in the example shown in FIG. 2). Referring to FIG. 2, for each of the time segments, an estimated travel time necessary to travel along the length of each link (e.g., A, B, or C), expressed in minutes, is defined.

The section information 30c shows an estimated travel distance per unit time in a case where the subject vehicle travels along roads included in each of a plurality of sections. In order to set these sections, a map is split into areas of a predetermined size (e.g., sections 10 kilometers square, which form a mesh). In other words, in the section information 30c, without specifying roads in each of the sections, an average travel distance per unit time in a case where the subject vehicle travels along roads included in the section is specified and defined as an estimated travel distance. FIG. 3 is an illustration showing the section information 30c. In this example, time segments are defined on the basis of a predetermined time interval (a fifteen-minute interval in the example shown in FIG. 3). Referring to FIG. 3, for each of the time segments, an average travel distance in a case where the subject vehicle travels along roads in each section (e.g., A, B, or C), expressed in km, is defined. Because the travel distance shows a travel distance that the subject vehicle can travel for each of the predetermined time intervals, the travel distance can be defined as an estimated travel distance per unit time for the predetermined time interval.

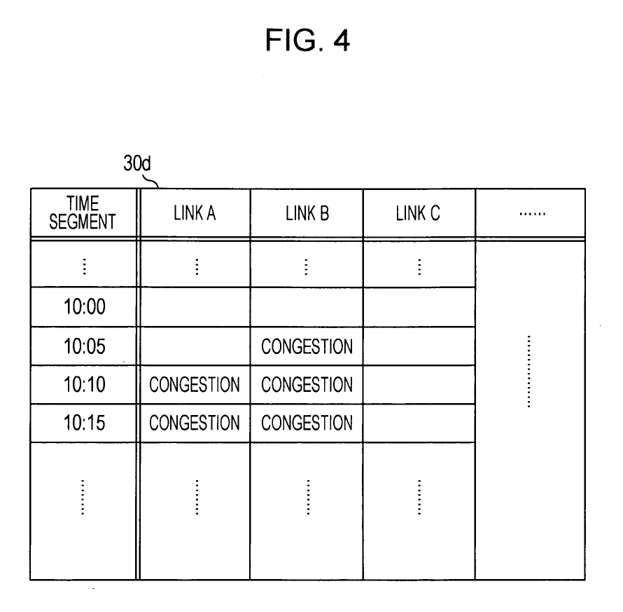

The congestion information 30d shows a congestion condition for each time segment for each link that is specified in advance on the basis of statistics. FIG. 4 is an illustration showing the congestion information 30d. In this example, time segments are defined on the basis of a predetermined time interval (a five-minute interval in the example shown in FIG. 4). For each time segment, whether congestion occurs along roads corresponding to each link (e.g., A, B, or C) is shown as data.

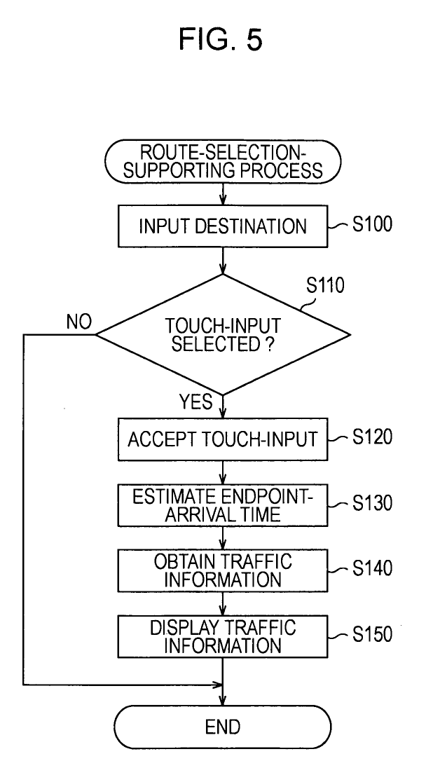

In this example, when a planned travel route from the present location to a destination is set in the navigation program 21, processes may performed in accordance with the exemplary route-selection-supporting method shown in FIG. 5. While the exemplary method shown in FIG. 5 may be implemented, for example, by one or more components of the above-described travel navigation apparatus 10, it should be appreciated that the structure of the navigation apparatus 10 is exemplary and the exemplary method need not be limited by any of the above-described exemplary structure.

As shown in FIG. 5, first, a destination for route guidance is input in the navigation program 21 (step S100). For example, a menu screen used to input the destination is displayed on the display unit 40, and an input of destination-selecting operation is accepted by an operation unit that is not shown in FIG. 1 or the touch-detection unit 41.

In this example, a process in which the control unit 20 searches for a route from the present location to the destination can be performed. Additionally, a process can be performed in which an operation of inputting a route is performed by a user touching the display surface of the display unit 40. Specifically, by performing a touch input, a user may specify a planned travel route himself/herself. In order to determine whether this process should be performed, the control unit 20 determines, in the navigation program 21, whether a user selects the process of inputting a planned travel route through a touch input (step S110).

In step S110, when it is determined that the user has not selected the process of specifying a route using a touch input, steps S120 to S150 are skipped and the method ends. Thus, the control unit 20 searches for and determines a route from the present location to the destination. However, when it is determined that the user has selected the process of specifying a rout using a touch input, the control unit 20 provides processes of supporting route selection performed using a touch input in steps S120 to S150.

In order to perform these processes, for example, the navigation program 21 provides the functions of a planned-travel-route-accepting unit 21a, an endpoint-arrival-time-estimating unit 21b, a traffic-information-obtaining unit 21c, and a display-control unit 21d. The display-control unit 21d can output a signal to the display unit 40 so that a corresponding image is displayed on the display unit 40. For the setting of a planned travel route, the display-control unit 21d refers to the map information 30a to obtain information concerning roads as candidates for the planned travel route and displays a map image including the roads on the display unit 40.

With the map image displayed on the display unit 40, the planned-travel-route-accepting unit 21a accepts the above-described touch input (step S120). In other words, the planned-travel-route-accepting unit 21a receives a signal output from the touch-detection unit 41. On the basis of this output signal, the planned-travel-route-accepting unit 21a obtains a position where a finger of the user (or the like) has touched the display surface. The positions of roads on the map displayed on the display unit 40 under the control of the display-control unit 21d are known in advance. Accordingly, the planned-travel-route-accepting unit 21a refers to the map information 30a to determine whether the touched position corresponds to the position of a road on the map. When the touched position corresponds to the position of a road on the map, the planned-travel-route-accepting unit 21a accepts the selection of the road.

Additionally, when a finger (or the like) continuously touches the display surface, the planned-travel-route-accepting unit 21a recognizes that roads corresponding to the trajectory of the touched positions are selected. In such a case, when the selected roads constitute a continuous road route, the planned-travel-route-accepting unit 21a accepts the continuous road route as a planned travel route. In this example, the starting point of a planned travel route is the present location, and the endpoint of the planned travel route is the location corresponding to the position touched with a finger or the like on the display unit 40. The display-control unit 21d displays the planned travel route on the display unit 40. Specifically, in this example, the planned travel route is highlighted (for example, displayed with thick line) on the map so that it can be distinguished from other roads. The display-control unit 21d outputs a signal used to perform the highlighted display to the display unit 40.

After the planned-travel-route-accepting unit 21a accepts the planned travel route, the endpoint-arrival-time-estimating unit 21b estimates an endpoint-arrival time at which the subject vehicle can reach the endpoint of the planned travel route (step S130). In other words, the endpoint-arrival-time-estimating unit 21b refers to the link information 30b to estimate an endpoint-arrival time at which the subject vehicle can reach the endpoint by traveling the planned travel route.

In this example, an endpoint-arrival time is calculated by estimating a travel time in a case where the subject vehicle starts from the present location at the present time on the basis of the link information 30b. Specifically, regarding the planned travel route, an estimated travel time corresponding to a link from the present location as a reference point to the next node is obtained, and then the estimated travel time is added to the present time to obtain an estimated time of arrival at the next node. After that, this next node is considered as a reference point and a process similar to the above-described process is repeated. The process is repeated until reaching the endpoint of the planned travel route (the current location of the user's finger), whereby the endpoint-arrival time is estimated. When the endpoint of the planned travel route does not coincide with any node, for example, a process in which an estimated travel time is corrected in accordance with the ratio of the distance corresponding to a link to the distance from a node of the link to the endpoint may be performed to obtain the corrected estimated travel time as an estimated travel time corresponding to the link.

After the endpoint-arrival-time-estimating unit 21b estimates the endpoint-arrival time, the traffic-information-obtaining unit 21c obtains traffic information concerning each road located between the endpoint of the planned travel route and the destination (step S140). Specifically, the traffic-information-obtaining unit 21c refers to the section information 30c and the congestion information 30d to obtain traffic information for a case where the subject vehicle starts to travel from the endpoint of the planned travel route to an arbitrary road. In this example, on the basis of the estimated travel distances defined on a per-unit-time basis defined in the section information 30c, the traffic-information-obtaining unit 21c obtains an arbitrary-road-arrival time at which the subject vehicle can reach an arbitrary road in a case where the subject vehicle travels from the endpoint to the arbitrary road. Then, with reference to the congestion information 30d, the traffic-information-obtaining unit 21c obtains traffic information for the arbitrary-road-arrival time. Traffic information in this example includes congestion information for each link and the above-described estimated travel distances for fifteen-minute intervals.

In this example, the traffic-information-obtaining unit 21c refers to the section information 30c for a section including the endpoint of the planned travel route in order to obtain the arbitrary-road-arrival time. The traffic-information-obtaining unit 21c obtains estimated travel distances that the subject vehicle can travel after the time segment including the endpoint-arrival time and which are defined for fifteen-minute intervals. When the endpoint-arrival time is not a boundary value (0, fifteen minutes, etc.) of one of the time segments included in the section information 30c, the endpoint-arrival time is corrected.

For example, in the example shown in FIG. 3, when an endpoint-arrival time at which the subject vehicle can reach an endpoint included in the section A is 10:10, an estimated travel distance defined in the section information 30c for a time segment from 10:00 to 10:15, which includes in the endpoint-arrival time, is 15 km. However, since a range of time in which the subject vehicle can travel after the endpoint-arrival time is from 10:10 to 10:15, 15 km is multiplied by 5/15 to obtain 5 km as a corrected estimated travel distance. After 10:15, each of 10 km, 10 km, and 5 km is obtained as an estimated travel distance for a fifteen-minute interval in accordance with the estimated travel distances for the section A defined in the section information 30c.

When the estimated travel distances that the subject vehicle can travel after the endpoint-arrival time in specified in the above-described manner, distances that the subject vehicle can travel for specified time intervals are specified. As a result, an arbitrary-road-arrival time can be easily estimated on the basis of the distances that the subject vehicle can travel for the specified time intervals. Specifically, in this example, concentric circles whose center is the endpoint of the planned travel route and whose radii are the sums of the estimated travel distances described above are defined, thereby estimating the arbitrary-road-arrival time.

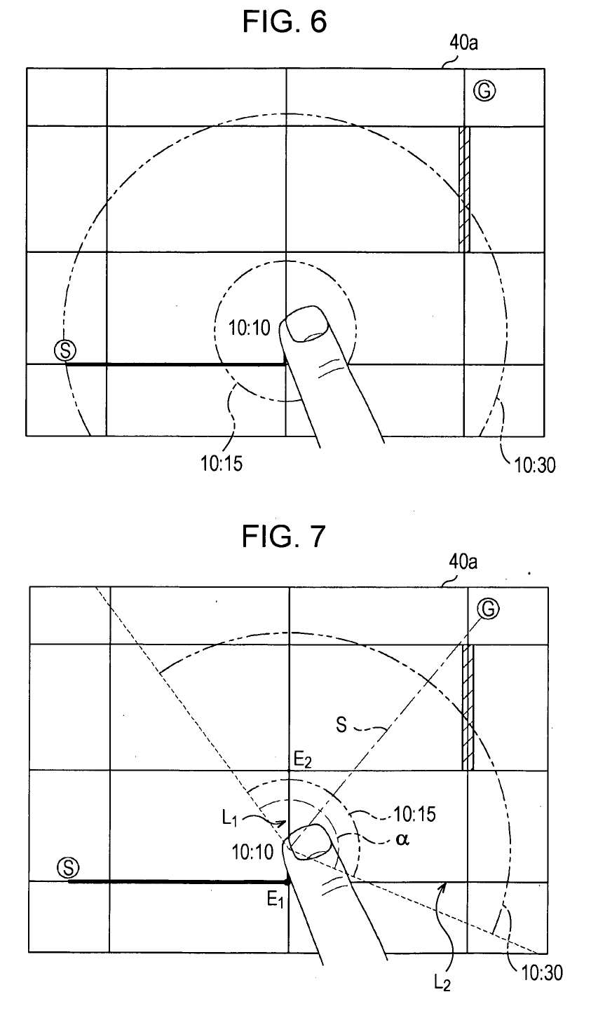

FIG. 6 is an illustration exemplifying a state in which a map is displayed on a display surface 40a of the display unit 40. Such a display is obtained under the control of the display-control unit 21d described below. FIG. 6 is also an illustration showing the estimation of arbitrary-road-arrival times performed by the traffic-information-obtaining unit 21c. Specifically, the two-dot-chain lines shown in FIG. 6 form concentric circles whose center is the endpoint of the planned travel route and whose radii are the sums of the estimated travel distances, described above. These concentric circles are shown for the case where the estimated travel distances for fifteen-minute intervals are obtained as shown in the above-described example.

In other words, an example in which the endpoint-arrival time, at which the subject vehicle can reach the endpoint of the planned travel route, is 10:10 is shown in FIG. 6. The concentric circles with two-dot chain lines are circles whose respective radii are the estimated travel distance for the time segment from 10:10 to 10:15 and the estimated travel distance for the time segment from 10:10 to 10:30. When the above-described concentric circles are shown, a time at which the subject vehicle can reach the periphery of each of the circles can be estimated to be 10:15 or 10:30. An arbitrary-road-arrival time at which the subject vehicle can reach an arbitrary road located between the peripheries of these circles can be also easily estimated.

For example, an interpolation operation or the like can be performed to obtain such an arbitrary-road-arrival time. When the arbitrary-road-arrival time is obtained in the above-described manner, the traffic-information-obtaining unit 21c refers to the congestion information 30d to determine whether or not there is congestion at the arbitrary-road-arrival time. When information showing congestion of the arbitrary road is included in the congestion information 30d, the traffic-information-obtaining unit 21c obtains the information as congestion information concerning the arbitrary road.

The display-control unit 21d displays the congestion information concerning the arbitrary road obtained in the above-described manner on the display unit 40 (step S150). In this example, the congestion information is highlighted (for example, in a color for a road with a congestion that is different from a color for other roads) so that the road with the congestion can be distinguished from other roads. A configuration in which traffic information other than congestion information, for example, an arbitrary-road-arrival time, is displayed may be used.

Returning to FIG. 6, on the map, the present location and the destination are represented by S and G, respectively. When the touch input is accepted to specify the planned travel route in the above-described step S120, the planned travel route is highlighted on the display surface 40a. Specifically, the planned travel route is displayed with thick line, and roads other than the planned travel route are displayed with thin lines. A state in which the planned travel route is selected by being touched with a human finger is shown in FIG. 6. In the process of step S120, a position on the display surface 40a touched with the human finger represents the endpoint of the planned travel route, and the position of this endpoint is continually changed in accordance with the movement of the finger.

When the display-control unit 21d performs the above-mentioned process of step S150, a link with a high probability of occurrence of congestion, which is specified in the process of step S140, is highlighted. The hatched portion in FIG. 6 shows a state in which the highlighted link is displayed. In the display described above, because the congestion information concerning each road is displayed while the user provides a touch input with a finger of the user, the user can set the planned travel route so as to avoid congestion. In this example, although the above-described concentric circles with two-dot chain lines are not displayed on the display unit 40, the concentric circles or the arbitrary-road-arrival time may be displayed on the display unit 40.

In the configuration described above, the endpoint-arrival time can be estimated on the basis of the planned travel route that is selected by the user and that is already determined. In other words, the endpoint-arrival time can be estimated on the basis of estimated travel times for links included in the planned travel route. Accordingly, the endpoint-arrival time can be accurately estimated. Additionally, in this example, the arbitrary-road-arrival time at which the subject vehicle can reach an arbitrary road in a case where the subject vehicle starts the endpoint at the endpoint-arrival time is estimated. Accordingly, the arbitrary-road-arrival time at which the subject vehicle can reach an arbitrary road in a case where the subject vehicle starts the present location of the subject vehicle or the traffic information can be estimated in a condition in which a location closer to the arbitrary road is considered as a reference point (the endpoint of the planned travel route is considered as a reference point), compared with in a condition without specifying any planned travel route. Thus, more accurate traffic information can be obtained.

In the above-described example, when the user inputs the planned travel route through a touch input, traffic information concerning an arbitrary road along which the subject vehicle can travel after reaching the endpoint of the planned travel route can be provided for the user. While various features have been described in conjunction with the example outlined above, various alternatives, modifications, variations, and/or improvements of those features and/or examples may be possible. Accordingly, the above example and the below variations are intended to be illustrative. Various changes may be made without departing from the broad spirit and scope of the underlying principles.

For example, in the above-described example, regarding the display of traffic information, traffic information concerning roads located in arbitrary directions in a case where the endpoint of the planned travel route is considered as a center is displayed on the display unit 40. However, a configuration in which only traffic information that is likely to be located along the route is displayed to avoid a display of useless information may be used.

Specifically, as the single-dot-chain line indicates in FIG. 7, traffic information may be displayed in a range of a sector with a central angle a whose center is the endpoint of the planned travel route and which is symmetric with respect to a straight line K running from the endpoint to the destination G (the one-dot chain line shown in FIG. 7). With this configuration, the process of the display can be performed only for necessary and sufficient traffic information (traffic information concerning each road located in a direction from the endpoint of the planned travel route to the destination), whereby the load of processes can be reduced.

The central angle a of the sector shown in FIG. 7 is equal to or smaller than 180°. Arbitrary roads located on the destination side with respect to a line that is perpendicular to the straight line K and that passes the endpoint may be set so as to be included in objects whose traffic information is to be displayed. The sector may be appropriately adjusted. The shape showing a range in which objects whose traffic information is to be displayed is not limited to a sector. For example, a configuration in which roads included in each of various types of polygons that uses the endpoint as one of the apexes and that includes the destination are considered as the arbitrary roads may be used. Additionally, a configuration in which only traffic information concerning roads or points located in a predetermined range set in the vicinity of the endpoint of the planned travel route is displayed may be used, thereby reducing the load of processes.

Furthermore, a route that the subject vehicle can take after reaching the endpoint of the planned travel route (a route by which the subject vehicle approaches from the endpoint to the destination) may be estimated on the basis of connections of links. Any route other than the estimated route may be excluded from objects whose traffic information is to be provided. For example, the endpoint of the planned travel route selected by being touched with a finger shown in FIG. 7 is a middle point of a link L₁. In order to travel along a link L₂ extending from a node E₁ that is a terminal point of the link L₁ and that is located farther from the destination than the other terminal node E₂ of the link L₁, it would be necessary for the subject vehicle to travel in a direction opposite to the direction from the selected endpoint of the planned travel route to the destination, or to take a detour including a route by which the subject vehicle must make a u-turn.

In such a case, the following configuration may be used: a node E₂ that is a terminal node of the link L₁ and that is located closer to the destination than the other terminal node E₁ of the link L₁ is considered as the endpoint of the planned travel route. Thus, only a link that extends from the node E₂ and that allows the subject vehicle to approach the destination is considered as an object whose traffic information is to be provided. That is, link L₂ is excluded. In this configuration, because only necessary and sufficient traffic information will be processed, the load of processes can be reduced.

Furthermore, a route that the subject vehicle can take after reaching the endpoint of the planned travel route can be estimated in various types of manners. For example, a configuration in which roads excluding the roads located on the side of the specified planned travel route are considered as the candidates for a route to be estimated may be used.

In the above-described example, in the link information 30b, the section information 30c, and the congestion information 30d, the information for links or sections is defined for each time segment. However, an estimated travel time or congestion information for each link, or an estimated travel distance for each section may be defined in accordance with a type of a road, such as an ordinary road or an expressway. Regarding a time segment, the information for links or sections may be classified and defined by an element by which information can be changed, such as a season, a day of week, a holiday, a day on which an event takes place, in addition to a classification by a fixed time interval.

Furthermore, it is only necessary for the traffic information to be traffic information that is referred to in a case where the user selects a planned travel route that the subject vehicle can take after reaching the endpoint. Accordingly, the traffic information need not be limited to congestion information, and may be regulatory information. Additionally, it is only necessary for the link information 30b, the section information 30c, and the congestion information 30d to be written in the storage medium 30 before they are referred to. Not a configuration in which these information are generated in advance and written in a storage medium, but also a configuration in which these information are obtained through various communications, such as vehicle-to-vehicle communications, road-to-vehicle communications, satellite communications, or communications with a distribution center that distributes congestion information, and sequentially updated may be used.

Weighting (e.g., levels) may be applied to information obtained through a communication and information written in a storage medium, and the information after the weighting may be added. The congestion information may show not only whether there is congestion but also the level of congestion. The congestion information may be associated with regulatory information. For example, a configuration in which the occurrence of congestion with different levels is estimated in accordance with the type of a regulation may be used.

The above-described traffic-information-obtaining unit 21c estimates the arbitrary-road-arrival time at which the subject vehicle can reach an arbitrary road on the basis of information for the section including the endpoint of the planned travel route. However, it is only necessary for the traffic-information-obtaining unit 21c to be capable of obtaining traffic information for a case where the subject vehicle starts to travel from the endpoint, and may obtain the arbitrary-road-arrival time in another manner. For example, an average distance from a central location of the section including the endpoint of the planned travel route to a central location of another section may be calculated. A time necessary to travel for the average distance may be roughly estimated on the basis of the estimated travel distances defined on a per-unit-time basis defined in the section information 30c.

In such a case, the arbitrary-road-arrival time at which the subject vehicle can reach an arbitrary road included in another section may be different for each section. Additionally, in order to reduce the load of processes, the estimation of the arbitrary-road-arrival time may be omitted, and traffic information concerning the arbitrary road for the endpoint-arrival time may be obtained. Any road including a point different from the endpoint can be used as the arbitrary road. Additionally, when the subject vehicle travels by the planned travel route, it is preferable that the arbitrary road does not include the endpoint, and that the arbitrary road be located in a direction allowing the subject vehicle not to return to the direction of the planned travel route.

It is only necessary for the touch-detection unit 41 to be capable of detecting touching of a display surface to accept a selection of a continuous road route. The touch-detection unit 41 may be configured to detect being touched with a finger or to detect being touched with an input device, such as a stylus. Various types of methods can be used as the detection method. Various types of touch panels, for example, that can detect a pressure to a display surface, or a capacitance or an optical change on a display surface can be used.

When the planned-travel-route-accepting unit 21a accepts a selection of a continuous road route, the planned-travel-route-accepting unit 21a may be configured to detect touching of a display surface according to a movement of tracing a road on the display surface to accept an input of the planned travel route. The planned-travel-route-accepting unit 21a may also have a configuration in which an operation of selecting an individual road is repeated to accept an input of the planned travel route. Furthermore, it is only necessary for the planned-travel-route-accepting unit 21a to be capable of accepting a selection of a continuous road route, and the configuration of the planned-travel-route-accepting unit 21a is not limited to a configuration in which the planned-travel-route-accepting unit 21a detects touching of a display surface to accept a selection. The planned-travel-route-accepting unit 21a may use a configuration in which a road displayed on a display unit is selected with an input device, such as a cross key or a remote controller.

The starting point of the planned travel route may be the present location of the subject vehicle as described above and may also be another point. For example, an arbitrary point selected by the user, or the like can be used as the starting point. The stating time at the starting point is not limited to the present time, and a configuration in which an arbitrary time selected by the user, or the like is used as the starting time may be used.

In the above-described example, distances that the subject vehicle can travel are defined for specified time intervals in the section information 30c. Then, a plurality of circles whose center is the endpoint of the planned travel route and whose radii are the sums of the distances that the subject vehicle can travel for time intervals in are defined. Consequently, times at which the subject vehicle can reach the vicinity of the circumferences of the circles are estimated. However, the method for obtaining the arbitrary-road-arrival time is not limited such a method.

When the section information 30c is referred to, as described above, only the estimated travel distance per unit time for the section including the endpoint of the planned travel route may be referred to. An estimated travel distance per unit time for each section in which the subject vehicle can travel in a case where the subject vehicle travels from the section including the endpoint of the planned travel route to a section including an arbitrary road may be referred to.

Information showing an estimated travel time set for each time segment for each section set on a map may be used as the section information 30c. In other words, when such information is referred to as the section information 30c, information showing an estimated travel time necessary to travel from a certain section to an adjoining section or another section can be obtained. Accordingly, an estimated travel time necessary to travel from the section including the endpoint of the planned travel route to a section including the arbitrary road can be easily obtained. Thus, when such an estimated travel time is added to the endpoint-arrival time, the arbitrary-road-arrival time can be obtained.

In the above-described embodiment, the traffic information is defined for each link. However, after traffic information is defined for each time segment for each section, a configuration in which the traffic information for each section is displayed may be used. Traffic information concerning an arbitrary road can be obtained in a process with a light load.

What is claimed is:

1. A route-selection-supporting device comprising:
a display that displays a map; and
a controller that:
accepts a selection of a continuous road route on the map as a planned travel route, the planned travel route having an endpoint;
estimates an endpoint-arrival time, the endpoint-arrival time representing a time at which a vehicle traveling the planned travel route can reach the endpoint;
obtains traffic information representing a state of traffic for travel beginning at the endpoint at the endpoint-arrival time; and
displays the obtained traffic information on the display.

2. The route-selection-supporting device according to claim 1, wherein the controller:
detects a touching of a surface of the display; and
accepts the touching of the surface of the display as the selection of the continuous road route.

3. The route-selection-supporting device according to claim 1, wherein the controller:
refers to a storage medium storing estimated travel times, the estimated travel times being stored for time segments of links; and
adds the estimated travel times for time segments of links corresponding to the planned travel route to a starting time set in advance to obtain the endpoint-arrival time.

4. The route-selection-supporting device according to claim 3, further comprising the storage medium.

5. The route-selection-supporting device according to claim 1, wherein the controller:
obtains an arbitrary-road-arrival time, representing a time at which the vehicle will reach an arbitrary road if it travels to the arbitrary road from the endpoint; and
obtains traffic information representing a state of traffic on the arbitrary road at the arbitrary-road-arrival time.

6. The route-selection-supporting device according to claim 1, wherein the controller:
refers to a storage medium that stores at least one of:
an estimated travel distance per unit time for each time segment of each section set on the map; and
an estimated travel time for each of the time segments of each of the sections set on the map; and
obtains a time as an arbitrary-road-arrival time representing a time at which the vehicle will reach an arbitrary section of the map if it starts to travel to the arbitrary section from the endpoint at the endpoint-arrival time on the basis of the stored estimated travel distances or the stored estimated travel times.

7. The route-selection-supporting device according to claim 6, further comprising the storage medium.

8. The route-selection-supporting device according to claim 1, wherein the controller:
accepts an input of a destination; and
obtains traffic information for an arbitrary road located in a linear direction from the endpoint of the planned travel route to the destination.

9. A route-selection-supporting method comprising:
displaying a map on a display;
accepting a selection of a continuous road route on the map as a planned travel route, the planned travel route having an endpoint;
estimating an endpoint-arrival time, the endpoint-arrival time representing a time at which a vehicle traveling the planned travel route can reach the endpoint;
obtaining traffic information representing a state of traffic for travel beginning at the endpoint at the endpoint-arrival time; and
displaying the obtained traffic information on the display.

10. The route-selection-supporting method according to claim 9, further comprising:
detecting a touching of a surface of the display; and
accepting the touching of the surface of the display as the selection of the continuous road route.

11. The route-selection-supporting method according to claim 9, further comprising:
referring to a storage medium storing estimated travel times, the estimated travel times being stored for time segments of links; and
adding the estimated travel times for time segments of links corresponding to the planned travel route to a starting time set in advance to obtain the endpoint-arrival time.

12. The route-selection-supporting method according to claim 9, further comprising:
obtaining an arbitrary-road-arrival time, representing a time at which the vehicle will reach an arbitrary road if it travels to the arbitrary road from the endpoint; and
obtaining traffic information representing a state of traffic on the arbitrary road at the arbitrary-road-arrival time.

13. The route-selection-supporting method according to claim 9, further comprising:
referring to a storage medium that stores at least one of:
an estimated travel distance per unit time for each time segment of each section set on the map; and
an estimated travel time for each of the time segments of each of the sections set on the map; and
obtaining a time as an arbitrary-road-arrival time representing a time at which the vehicle will reach an arbitrary section of the map if it starts to travel to the arbitrary section from the endpoint at the endpoint-arrival time on the basis of the stored estimated travel distances or the stored estimated travel times.

14. The route-selection-supporting method according to claim 9, further comprising:
accepting an input of a destination; and
obtaining traffic information for an arbitrary road located in a linear direction from the endpoint of the planned travel route to the destination.

15. A computer-readable storage medium storing a computer executable program usable to support route selection, the program comprising:
instructions for displaying a map on a display;
instructions for accepting a selection of a continuous road route on the map as a planned travel route, the planned travel route having an endpoint;
instructions for estimating an endpoint-arrival time, the endpoint-arrival time representing a time at which a vehicle traveling the planned travel route can reach the endpoint;
instructions for obtaining traffic information representing a state of traffic for travel beginning at the endpoint at the endpoint-arrival time; and instructions for displaying the obtained traffic information on the display.
